(19) United States
(12) Patent Application Publication
(10) Pub. No.: US 2026/0280112 A1
(43) Pub. Date: Sep. 17, 2026

(54) QUICK DEPLOYABLE DISASTER SATELLITE EARTH TERMINAL

(71) Applicant: CINETCOMM, LLC, Las Vegas, NV (US)

(72) Inventor: Tom D. SOUMAS, JR., Las Vegas, NV (US)

(73) Assignee: CINETCOMM, LLC, Las Vegas, NV (US)

(21) Appl. No.: 19/360,849

(22) Filed: Oct. 16, 2025

Related U.S. Application Data
(60) Provisional application No. 63/709,171, filed on Oct. 18, 2024.

(51) Int. Cl. H01Q 1/42; H01Q 1/02

(52) U.S. Cl. CPC H01Q 1/422; H01Q 1/02

(57) ABSTRACT

An antenna assembly including a radome having a top section and a base section. The top section may be substantially hemispherical in shape and may have a top flange that extends outwards from a base of the hemisphere. The top section may be made of one or more layers of fiberglass and a RF transparent material. The one or more layers of fiberglass may be tapered to stop approximately 6″ above the top flange. The base section may have a base flange that is joined to the top flange. The base section may be substantially conical in shape such that it tapers from the base flange to a bottom area having a smaller diameter. The bottom area may be configured to mount to a support structure.

### CROSS-REFERENCE TO RELATED APPLICATIONS

This application claims benefit of U.S. Provisional Patent Appln. No. 63/709,171 filed on Oct. 18, 2024. The entirety of this application is hereby incorporated herein by reference.

### TECHNICAL FIELD

The present disclosure generally relates to communication systems for emergency disaster communications, and more particularly to methods, processes, and apparatuses for the protection of antenna assemblies (e.g., for satellite communicates and mobile networks) from weather and atmospheric conditions.

### BACKGROUND

When an earthquake, flood, tornado, hurricane, blizzard, or other disaster strikes a region, existing communication infrastructure such as cell phone and radio towers are often damaged or destroyed. Wind and rainstorms often knock out communications to local emergency responders in hard-hit areas, limiting their ability to respond with needed aid immediately.

### SUMMARY

Methods, systems, and apparatuses for an antenna assembly system with protection that can be quickly deployed prior to or immediately after a disaster and withstand the extreme weather associated with disaster events. The antenna assembly system may include a radome having a top section and a base section. The top section may be substantially hemispherical in shape and may have a top flange that extends outwards from a base of the hemisphere. The top section may be made of one or more layers of fiberglass and a RF transparent material. The one or more layers of fiberglass may be tapered to stop approximately 6″ above the top flange. The base section may have a base flange that is joined to the top flange. The base section may be substantially conical in shape such that it tapers from the base flange to a bottom area having a smaller diameter. The bottom area may be configured to mount to a support structure.

### BRIEF DESCRIPTION OF THE DRAWINGS

The drawings described below are for illustration purposes only. The drawings are not intended to limit the scope of the present disclosure.

FIG. 1 is side view of an antenna assembly system including a radome and an antenna system, according to an example of the present disclosure;

FIG. 2 is a top view of the antenna assembly system, according to an example of the present disclosure;

FIG. 3A is a perspective view of the antenna assembly system attached to a support structure, according to an example of the present disclosure;

FIG. 3B is a side view of the antenna assembly system attached to the support structure, according to an example of the present disclosure;

FIG. 4 is a side view of the antenna assembly system attached to a proprietary support structure and base, according to an example of the present disclosure;

FIG. 5 is a top view of the base, according to an example of the present disclosure.

### DETAILED DESCRIPTION

Preserving lines of communication before and during disaster events and restoring emergency communications as quickly as possible after disaster events is vital for coordinating rescue and relief efforts. However, extreme weather, such as wind and precipitation in the form of snow, rain, sleet, hail, etc. can make it extremely difficult to maintain operation of ground-based antennas and terminals. For example, wind can knock a satellite terminal out of alignment or completely blow it over and/or away. Accumulating precipitation such as snow and/or ice can build up on an antenna and inhibit communications. These problems may be exacerbated in satellite terminals that utilize dish-shaped parabolic antennas and/or flat panel antennas.

Extreme weather can also make it dangerous for technicians or other personnel to address these conditions. In conventional systems, wherein prior to disasters or on the eve of an impending disaster, a trained professional may have to secure the earth terminal to prevent damage thereto from the disaster. Similarly, in such systems, after the disaster, the trained professional may have to go back to the site and restore communications. In these systems, communications are lost at the most critically needed time of a disaster. Accordingly, an improved antenna system with protection from natural disasters is desirable.

Described herein is an antenna assembly system with protection that can be quickly deployed prior to or immediately after a disaster and withstand the extreme weather associated with disaster events. The system may be installed on a tower, building, vehicle, or vessel. It may provide satellite and/or cellular communications, including data, voice, video and/or Internet before, during and after a disaster, maintaining critically needed essential communications.

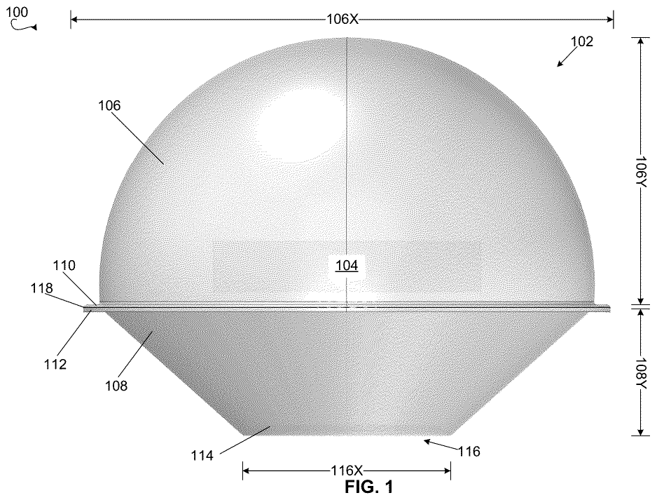

Referring now to FIG. 1, a profile view of an antenna assembly system 100 including a radome 102 and an antenna system 104 is shown. The antenna assembly system 100 may be small and lightweight such that two persons can lift it manually or with a simple hand operated winch, for example, with one person operating the winch and the other using a guy line to guide the radome 102 during the lift.

The radome 102 may house and protect the antenna system 104, which may include components of one or more of a satellite earth terminal and a mobile network base station. The antenna system 104 may include one or more of an antenna, antenna positioner, low noise amplifier, and block up-converter (not shown). In an example, the antenna system 104 may include one or more of a flat panel Ku-Band network terminal for communication with low earth orbit (“LEO”) satellites and one or more cellular antennas (e.g., 4G LTE and/or 5G). The one or more cellular antennas may include four separate antennas that are separated from one another by approximated 90 degrees.

The radome 102 may include a top section 106 and a base section 108. The radome 102 may have a shape that cause wind to cancel from top to bottom and side to side. The top section 106 and the base section 108 may be joined together by a top flange 110 on the top section 106 that overlaps a base flange 112 on the base section. The top section 106 and the base section 108 may be secured to each other by one or more bolts and nuts. In an example, the top section 106 may have a diameter of 106X at its bottom of approximately 46.38″ and a height 106Y of approximately 24.18″ and the bottom section 108 may have a bottom area 116 with a diameter 116X of approximately 18″ and a height 108Y of approximately 11.38″. The radome 102 may be sized such that it can be easily moved (e.g., through standard doorways).

The top section 106 may be substantially hemispherical in shape with the top flange 110 extending outwards from a base of the hemisphere. This shape presents essentially a constant range of angles of incidence for all elevation angles above the horizon, independent of azimuth angle. The base section 108 may have substantially conical shape that tapers from the base flange 112 to the bottom area 116. In an example, the bottom area 116 may be flat. In another example, the bottom area 116 may be configured to mount upon a pole, tower, rooftop, or other supporting structure. In an example, the bottom area 116 may be the interface for the antenna system 104 within the radome 102 and for mounting the radome 102 to the supporting structure. In an example, the radome 102 may be mounted to a non-penetrating support, for example, those manufactured by Baird Satellite Support Systems.

In an example, a flexible gasket 118 may be located between the top section 106 and the bottom section 108 to provide a weather seal for the radome 102.

The top section 106 may minimize the effect on RF energy passing through the radome 102 (i.e., may be RF transparent). This design may depend upon several factors, including, for example, the operating frequency band, the range of angles of incidence that rays emanating from the normal to the aperture of the antenna system 104 in the direction of propagation of the RF energy, dielectric properties of the materials, and method of construction. Radome RF design is well documented in Massachusetts Institute of Technology Radiation Laboratory Series, Volume 26, the entire contents of which are hereby incorporated by reference. These principles may be applied to the radome 102 with consideration for structural properties to achieve a design that may withstand 200 mph winds with rain and hail.

The top section 106 may be made of one or more layers of materials including, but not limited to: 1708 biaxial fiberglass cloth fabric, 7781 fiberglass cloth fabric, a RF transparent material such as a polyvinyl chloride foam core (e.g., Divinycell manufactured by Diab Group), and a gelcoat. In an example the top section 106 may be made of one or more layers (e.g., 4 layers) of 1708 biaxial fiberglass cloth fabric tapered up to stop approximately 6″ above the top flange 110, a first layer of 7781 fiberglass cloth fabric, a layer of Divinycell having a thickness of approximately ⅛″, a second layer of 7781 fiberglass cloth fabric, and a gelcoat.

The base section 108 may be designed for structural strength and/or without regard for RF properties. In one example, none of the RF energy of the antenna system 104 may pass through the base section 108. In this manner, the antenna system 104 inside the radome 102 may not be affected by the happenings outside the radome 102 since the antenna system 104 is mounted securely to the base section 108. Moderate flexing of the radome 102 or top section 106 may have no effect on the performance of the antenna system 104 within the radome 102.

The bottom section 108 may be made of one or more layers of materials including, but not limited to: chopped strand fiberglass mat, a mounting plate 114, and 1708 biaxial fiberglass cloth fabric. In an example the bottom section 108 may be made of a layer of chopped strand fiberglass mat, one or more first layers (e.g., 3 layers) of 1708 biaxial fiberglass cloth fabric, a mounting plate 114 having a 17.58″ diameter and made from ½ ″ A36 steel, and one or more second layers (e.g., 2 layers) layers of 1708 biaxial fiberglass cloth fabric.

One or more of the top section 106 and the bottom section 108 may be made of a thermally conductive material. In an example, a heating element (not shown) may be included in the radome 102 and may be coupled to one or more of the top section 106 and the bottom section 108 (e.g., via wiring) to allow for the transfer of heat. The heating element may be located in the bottom section 108. The heating element may include a thermostat that activates the heating element if the exterior temperature is within a predetermined range (e.g., 27°-38° F.) to prevent an accumulation of snow and/or ice on the radome 102.

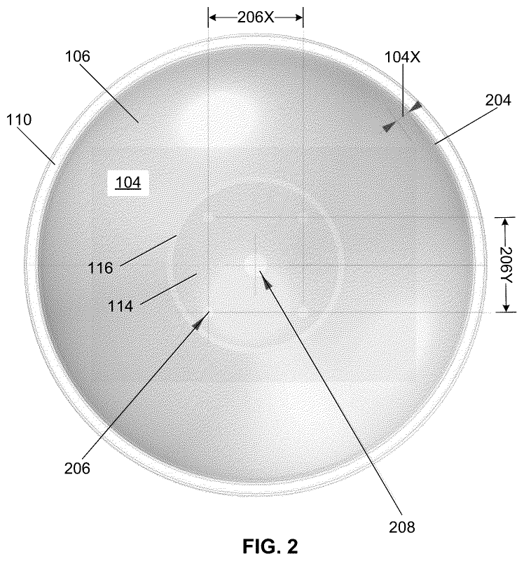

Referring now to FIG. 2, a top view of the antenna assembly system 100 is shown. The antenna system 104 may have a clearance 104X from an interior wall 204 of the radome 102. In an example, the clearance 104X may be approximately 1.36″. The bottom area 116 and the mounting plate 114 may have one or more openings. For example, a conduit opening 208 may allow for wiring that connects the antenna system 104 and any other components within the radome 102 to external equipment. In an example, the conduit opening 208 may have a diameter of approximately 2.38″. One or more fastener openings 206 may allow for the radome 102 to be attached to a supporting structure. In an example, there may be four fastener openings 206 that are separated by a horizontal distance 206X of 9.5″ and a vertical distance 206Y of 9.5″.

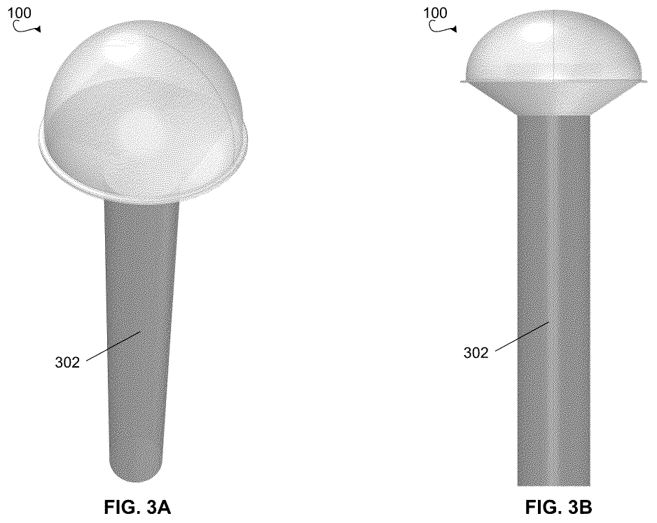

Referring now to FIGS. 3A and 3B, views of the antenna assembly system 100 attached to a support structure 302 are shown. FIG. 3A is a perspective view of the antenna assembly system 100 attached to the support structure 302. FIG. 3B is a side view of the antenna assembly system 100 attached to the support structure 302.

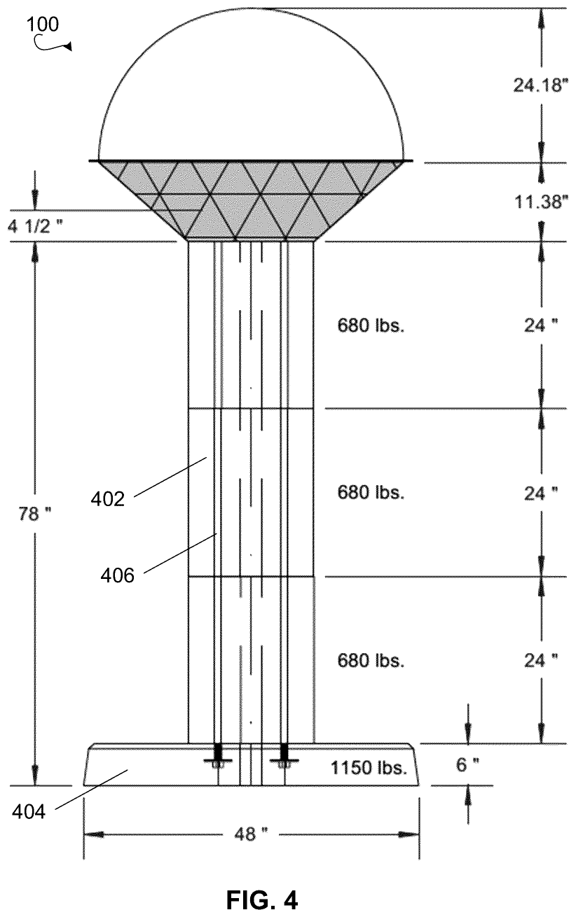

Referring now to FIG. 4, a side view of the antenna assembly system 100 attached to a proprietary support structure 402 and base 404 manufactured by Dixie Precast, Inc. is shown. The base 404 may be formed of precast concrete and may be 48″×48″. The support structure may include three 18″ diameter collars, each of which may be 24″ in height. The total combined weight of the support structure 402 and base 404 may be approximately 3200 lbs. The base 404 may have a 3″ conduit cast in place for wiring that may be fed into the radome 102. One or more bolts 406 may be anchored to the base 404 and may extend through the one or more fastener openings 206 to secure the antenna assembly system 100 to the support structure 402.

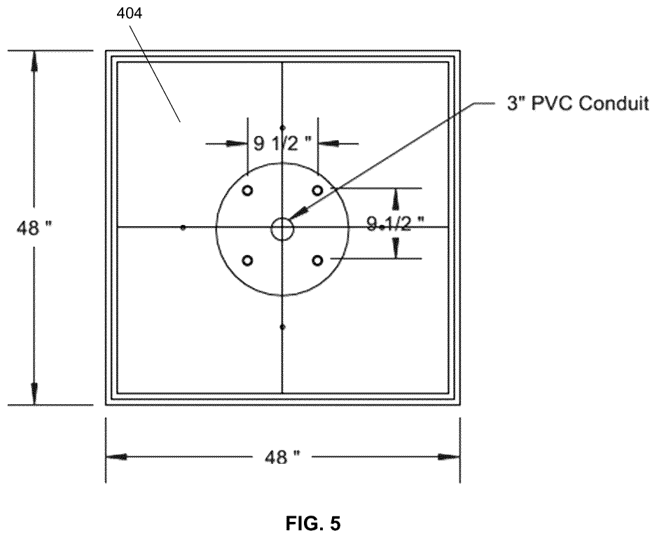

Referring now to FIG. 5, a top view of the base 404 is shown.

In one example, the antenna system 104 may be a VSAT (very small aperture terminal). In one example, the antenna system 104 may be a USAT (ultra small aperture terminal).

In one example, the antenna system 104 may be a VSAT that interfaces with one or more global networks. In one example, the VSAT may provide one or more of voice, data, and/or Internet telecommunications. The VSAT may be one-way or two-way (e.g., it may transmit only, receive only, or transmit and receive).

One example provides a system in which one or more radomes 102 and VSAT antenna system 104 may be used in a star, mesh or point to point network.

In one example, the antenna system 104 may have a size ranging from 55 cm to 9 m. This includes all sizes there between, including 55 cm, 2 m, 3.8 m, 7.8 m, and 9 m.

The antenna system 104 may transmit and/or receive signals in the Ka band, Ku band, X band, or C band, or any combination thereof.

The antenna system 104 may have a size less than or equal to 3.8 m in Ku band examples and less than or equal to 7.8 m in C band examples.

In one example, a system is provided having a VSAT network that includes a large high performance hub earth station (with an antenna of up to 9 m in diameter) and a large number of smaller, lower performance terminals, each using a radome 102.

The present system is particularly suited for interactive VSAT networks and one or more applications selected from the group including computer communications; reservation systems; database enquiries; billing systems; file transfers; electronic mail; video conferencing; point of sale transactions; credit checks and credit card verification; stock control and management; emergency communications; military applications; Federal Emergency Management Administration (FEMA); National Oceanographic and Atmospheric Administration (NOAA); storm communication; storm response; hurricane communication; hurricane evacuation; hurricane response; tornado communication; tornado evacuation; tornado response.

In one example, the VSAT configuration may be a TDM/TDMA star network, having a high bit rate outbound carrier (TDM) from the hub to the remote earth stations, and one or more low or medium bit rate Time Division Multiple Access (TDMA) inbound carriers. In another example the VSAT configuration may be a 4G LTE and/or 5G cellular communication network.

In one example, in addition to the antenna system 104, one or more communication devices may be present in the interior portion of the communications system. Examples of these devices include GSM terminal, emergency radio, police radio, fire radio, wireless LAN, or a combination thereof.

In one example, the antenna system 104 may not be stabilized. In another example, antenna system 104 may be stabilized.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Those skilled in the art will recognize that the methods and systems of the present disclosure may be implemented in many manners and as such are not to be limited by the foregoing examples. In other words, functional elements being performed by single or multiple components, in various combinations of hardware and software or firmware, and individual functions, may be distributed among software applications at either the client level or server level or both. In this regard, any number of the features of the different examples described herein may be combined into single or multiple examples, and alternate examples having fewer than, or more than, all of the features described herein are possible.

Functionality may also be, in whole or in part, distributed among multiple components, in manners now known or to become known. Thus, a myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the examples of methods presented and described as flowcharts in this disclosure are provided by way of example in order to provide a more complete understanding of the technology. The disclosed methods are not limited to the operations and logical flow presented herein. Alternative examples are contemplated in which the order of the various operations is altered and in which sub-operations described as being part of a larger operation are performed independently.

While various examples have been described for purposes of this disclosure, such examples should not be deemed to limit the teaching of this disclosure to those examples. Various changes and modifications may be made to the elements and operations described above to obtain a result that remains within the scope of the systems and processes described in this disclosure.

1. A radome for an antenna assembly system, comprising:
a top section that is substantially hemispherical in shape and having a top flange that extends outwards from a base of the hemisphere, the top section comprising one or more layers of fiberglass and a RF transparent material, wherein the one or more layers of fiberglass are tapered to stop a predetermined distance above the top flange; and
a base section having a base flange configured to be joined to the top flange, the base section substantially conical in shape such that it tapers from the base flange to a bottom area having a smaller diameter, wherein the bottom area is configured to mount to a support structure.

2. The radome of claim 1, wherein the top section comprises one or more layers of biaxial fiberglass cloth fabric, a first layer of fiberglass cloth fabric, a layer of polyvinyl chloride foam core, a second layer of fiberglass cloth fabric, and a gelcoat.

3. The radome of claim 2, wherein the one or more layers of biaxial fiberglass cloth fabric comprises four layers of biaxial fiberglass cloth fabric.

4. The radome of claim 1, wherein the base section comprises one or more layers of chopped strand fiberglass mat, one or more layers of biaxial fiberglass cloth fabric, and a mounting plate embedded within the one or more layers of biaxial fiberglass cloth fabric, the mounting plate made from steel.

5. The radome of claim 1, further comprising a flexible gasket located between the top section and the base section to provide a weather seal, wherein the top section and the base section are secured to each other by one or more bolts and nuts through the top flange and the base flange.

6. The radome of claim 1, wherein one or more of the top section and the base section is made of a thermally conductive material, and further comprising a heating element coupled to the one or more of the top section and the base section, the heating element comprising a thermostat that activates the heating element when an exterior temperature is within a predetermined range.

7. The radome of claim 1, wherein the bottom area comprises one or more fastener openings configured to attach the radome to the support structure and a conduit opening configured to allow wiring to pass therethrough.

8. The radome of claim 1, wherein the radome has a shape that causes wind to cancel from top to bottom and side to side.

9. The radome of claim 1, further comprising an antenna system housed within the radome, the antenna system comprising one or more of a satellite earth terminal and a mobile network base station.

10. The radome of claim 9, wherein the antenna system comprises one or more of a flat panel Ku-Band network terminal for communication with low earth orbit satellites and one or more cellular antennas.

11. A method of forming a radome for an antenna assembly system, comprising:
forming a top section that is substantially hemispherical in shape, the top section comprising one or more layers of fiberglass and a RF transparent material, wherein the one or more layers of fiberglass are tapered to stop a predetermined distance above a top flange that extends outwards from a base of the hemisphere;
forming a base section that is substantially conical in shape such that it tapers from a base flange to a bottom area having a smaller diameter, wherein the bottom area is configured to mount to a support structure; and
joining the base flange of the base section to the top flange of the top section.

12. The method of claim 11, wherein forming the top section comprises layering one or more layers of biaxial fiberglass cloth fabric, a first layer of fiberglass cloth fabric, a layer of polyvinyl chloride foam core, a second layer of fiberglass cloth fabric, and applying a gelcoat.

13. The method of claim 12, wherein the one or more layers of biaxial fiberglass cloth fabric comprises four layers of biaxial fiberglass cloth fabric.

14. The method of claim 11, wherein forming the base section comprises layering one or more layers of chopped strand fiberglass mat and one or more layers of biaxial fiberglass cloth fabric with a mounting plate made from steel embedded therein.

15. The method of claim 11, further comprising positioning a flexible gasket between the top section and the base section to provide a weather seal, and securing the top section and the base section to each other by one or more bolts and nuts through the top flange and the base flange.

16. The method of claim 11, further comprising coupling a heating element to one or more of the top section and the base section, the heating element comprising a thermostat configured to activate the heating element when an exterior temperature is within a predetermined range.

17. The method of claim 11, wherein the bottom area comprises one or more fastener openings configured to attach the radome to the support structure and a conduit opening configured to allow wiring to pass therethrough.

18. The method of claim 11, wherein the radome has a shape that causes wind to cancel from top to bottom and side to side.

19. The method of claim 11, further comprising housing an antenna system within the radome, the antenna system comprising one or more of a satellite earth terminal and a mobile network base station.

20. The method of claim 19, wherein the antenna system comprises one or more of a flat panel Ku-Band network terminal for communication with low earth orbit satellites and one or more cellular antennas.
